(19) United States
(12) Patent Application Publication
(10) Pub. No.: US 2016/0336745 A1
(43) Pub. Date: Nov. 17, 2016

(54) DYNAMIC POWER SHARING AMONG MULTIPLE PHYSICAL PORTS

(71) Applicant: Apple Inc., Cupertino, CA (US)

(72) Inventors: Manisha P. Pandya, Saratoga, CA (US); Nicholas A. Sims, San Francisco, CA (US)

(21) Appl. No.: 15/154,258

(22) Filed: May 13, 2016

Related U.S. Application Data
(60) Provisional application No. 62/161,811, filed on May 14, 2015.

(51) Int. Cl. H02J 1/00; H02J 7/00

(52) U.S. Cl. CPC H02J 1/00; H02J 7/0068

(57) ABSTRACT

The disclosed embodiments provide a charging device. The charging device includes a battery, a first physical port and a management apparatus. The management apparatus determines a first type and a first state of a first load device connected to the first physical port and allocates power supplied to the first load device through the first physical port according to the first type and the first state of the first load device.

### CROSS-REFERENCE TO RELATED APPLICATIONS

This application claims priority to U.S. Provisional Application No. 62/161,811, filed May 14, 2015, the contents of which are entirely incorporated by reference herein.

### BACKGROUND

The disclosed embodiments relate to techniques for providing power through physical ports in an electronic device. More specifically, the disclosed embodiments relate to techniques for dynamically sharing power among multiple physical ports.

Computer systems typically include physical ports that enable the connection of various peripheral devices to the computer systems and/or use of the peripheral devices by the computer systems. For example, a computer system such as a desktop computer, laptop computer, and/or display may include multiple Universal Serial Bus (USB) interfaces, which may be used to connect the computer system to non-volatile storage devices, optical disk drives, input/output (I/O) devices, network devices, printers, power adapters, portable electronic devices, and even other computer systems. Similarly, a charging device with a built-in battery may allow portable electronic devices such as mobile phones, portable media players, and/or tablet computers to be connected via USB and charged from the battery and/or an external power source such as a power adapter.

However, differences in the power requirements and/or preferences of the peripheral devices may result in the inefficient allocation of power through the physical ports to the peripheral devices and/or limited use of the peripheral devices. For example, an electronic device may be capable of delivering up to 7 W of power to load devices through USB and/or other physical ports on the electronic device. If one 5 W load device is connected to the electronic device, the load device may draw up to 5 W from the electronic device. If another 5 W load device is then connected to the electronic device, the power allocated to the second load device may be limited to the remaining 2 W available on the electronic device, even if the second load device has a greater need for power (e.g., lower battery level, higher power consumption, etc.) than the first load device.

Hence, what is needed is a mechanism for dynamically and efficiently allocating power to load devices through physical ports in electronic devices.

### SUMMARY

The disclosed embodiments provide a charging device. The charging device includes a battery, a first physical port and a management apparatus. The management apparatus determines a first type and a first state of a first load device connected to the first physical port and allocates power supplied to the first load device through the first physical port according to the first type and the first state of the first load device.

In some embodiments, allocating power supplied to the first load device through the first physical port includes allocating the power supplied to the first load device through the first physical port based on a coupling of an external power source to the charging device.

In some embodiments, when the external power source is not coupled to the charging device, the management apparatus allocates the power supplied to the first load device from a battery on the charging device at a level that is lower than a maximum allocation of power on the charging device.

In some embodiments, the management apparatus also determines a second type and a second state of a second load device connected to the second physical port, and allocates power supplied to the second load device through the second physical port according to the second type and the second state of the second load device.

In some embodiments, the management apparatus also determines a first priority of the first load device based on the first type and the first state of the first load device and determines a second priority of the second load device based on the second type and the second state of the second load device. Next, the management apparatus reallocates power supplied to the first and second load devices through the first and second physical ports according to the first and second priorities.

In some embodiments, the management apparatus also operates a battery in the charging device based on the first and second priorities.

In some embodiments, operating the battery in the charging device based on the first and second priorities includes one of disabling charging of the battery before the battery reaches a fully charged state to increase power supplied to the first and second load devices, and allocating power for charging the battery based on a battery level of the battery and the first and second priorities.

In some embodiments, reallocating power supplied to the first and second load devices according to the first and second priorities includes reducing power supplied to the first load device to accommodate the power supplied to the second load device.

In some embodiments, reallocation of the power supplied to the first and second load devices occurs upon detecting a connection of the second device to the second physical port of the charging device.

In some embodiments, the management apparatus also allocates power supplied to the first and second load devices based on user input from the first or second load devices.

In some embodiments, allocating power supplied to the first load device through the first physical port includes communicating a power allocation for the first load device to the first load device through the first physical port.

In some embodiments, allocating power supplied to the first load device through the first physical port further includes monitoring a power draw of the first load device, and limiting the power supplied to the first load device based on the monitored power draw and the power allocation.

In some embodiments, limiting the power supplied to the first load device based on the monitored power draw and the power allocation includes one of preventing the power supplied to the first load device from exceeding the power allocation, and disconnecting the first load device from the charging device when the monitored power draw exceeds the power allocation.

In some embodiments, communicating the power allocation for the first load device includes communicating a port type of the physical port to the first load device, wherein the port type is associated with the power allocation.

In some embodiments, the first state of the first load device includes one of a battery level of a battery in the first load device, a current load on the first load device, and a power draw of the first load device.

### BRIEF DESCRIPTION OF THE FIGURES

FIG. 1 shows a schematic of a system in accordance with the disclosed embodiments.

FIG. 2 shows the allocation of power to one or more load devices connected to a charging device in accordance with the disclosed embodiments.

FIG. 3 shows a flowchart illustrating the process of managing power allocation in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

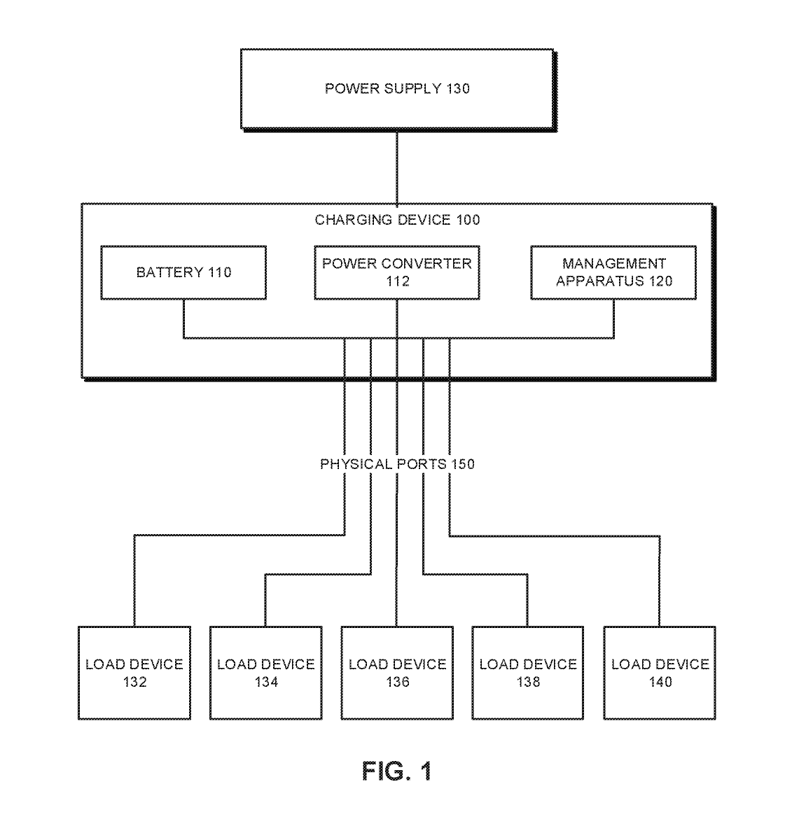

The disclosed embodiments provide a method and system for dynamically sharing power among multiple physical ports in a charging device. As shown in FIG. 1, a charging device 100 may be connected to a set of load devices 132-140 through a number of physical ports 150. Charging device 100 may be a laptop computer, external battery, and/or other type of electronic device with a battery 110. Charging device 100 may be connected to load devices 132-140 such as mice, keyboards, mobile phones, tablet computers, portable media players, optical drives, and/or digital cameras through a set of Universal Serial Bus (USB) ports, FireWire (FireWire™ is a registered trademark of Apple Inc.) ports, Thunderbolt (Thunderbolt′ is a registered trademark of Apple Inc.) ports, and/or other types of physical ports 150.

Charging device 100 may also be connected to a power supply 130 (e.g., mains power) that charges battery 110 and/or supplies power to load devices 132-140 connected to physical ports 150. Once a load device (e.g., load devices 132-140) is connected to a physical port (e.g., physical ports 150), a power converter 112 in charging device 100 may convert and route power from power supply 130 to the physical port to enable charging and/or operation of the load device. For example, power converter 112 may be a flyback converter that converts alternating current (AC) mains power into low-voltage direct current that is used to charge the battery of and/or power a mobile phone, portable media player, tablet computer, and/or other load device that can operate independently of charging device 100 and/or communicate with charging device 100. Alternatively, if power supply 130 is not available, charging device 100 may supply power from battery 110 to load devices 132-140 through physical ports 150.

Those skilled in the art will appreciate that different amounts of power may be allocated to and/or drawn by load devices (e.g., load devices 132-140) connected to the same type of physical port (e.g., physical ports 150). For example, a single USB interface may support both USB 2.0 devices, which initially use 100 mA of current and require up to 500 mA of current, and USB 3.0 devices, which initially use 150 mA of current and require up to 900 mA of current. A mobile phone connected to the USB interface may draw up to 5 W of power, while a tablet computer connected to the same USB interface may draw up to 10 W of power.

At the same time, load devices 132-140 may have different power demands and requirements, which depend on factors such as the battery capacities and battery levels of batteries in load devices 132-140, the current loads on load devices 132-140, and/or the overall power consumption of load devices 132-140. For example, the power drawn by a mobile phone or tablet computer from a USB port may vary based on the state-of-charge of the battery inside the mobile phone or tablet computer and/or the amount of power consumed by an electrical load in the mobile phone or tablet computer.

Moreover, power supply 130 and power converter 112 may only supply a limited amount of power, which is less than the total amount that can be drawn through physical ports 150. In turn, charging device 100 may be required to allocate limited power output from power converter 112 among battery 110 and load devices 132-140 connected to physical ports 150. If power supply 130 is not available (e.g., charging device 100 is not plugged in to a power outlet), an even smaller amount of output power from the discharging of battery 110 may be distributed among load devices 132-140 connected to physical ports 150. For example, charging device 100 may provide up to 12.5 W of power from power supply 130 and power converter 112 to multiple physical ports 150 that are each capable of drawing 10 W. If charging device 100 is not connected to mains power, charging device 100 may supply up to 10 W of power from battery 110 to physical ports 150.

In one or more embodiments, charging device 100 includes functionality to dynamically share limited power from power supply 130, power converter 112, and/or battery 110 among multiple physical ports 150 according to the types and/or states of load devices 132-140 connected to physical ports 150. For each load device 132-140 connected to a physical port in charging device 100, a management apparatus 120 in charging device 100 may determine the type and state of the load device. The type of the load device may include the manufacturer and/or model of the load device, such as “Apple iPad mini 3.” The type of the load device may also include characteristics of the load device, such as a device name, a device owner (e.g., a person's name or username), a screen size, a multimedia capability, a battery capacity of the load device, and/or a maximum power draw of the load device (e.g., 5 W, 10 W, etc.). The state of the load device may include the battery level (e.g., state-of-charge) of a battery in the load device, the current load (e.g., current power consumption) on the load device, and/or a power draw of the load device (e.g., the current amount of power drawn from the physical port by the load device).

Management apparatus 120 may identify the type and/or state of the load device by communicating with the load device. For example, management apparatus 120 may use USB, FireWire, Thunderbolt, and/or another wired communications interface to identify the manufacturer, model, battery level, battery capacity, maximum power draw (e.g., 5 W, 10 W, etc.), current load, current power drawn, and/or other attributes of the load device. Management apparatus 120 may also use information from the load device to derive and/or infer other attributes of the load device. For example, management apparatus 120 may match the manufacturer and/or model of the load device to an entry in a table that specifies the battery capacity, power consumption range, and/or maximum power draw of the load device. If the load device is not capable of communicating the type and/or state through the wired communications interface supported by physical ports 150, management apparatus 120 may skip determination of the type and/or state of the load device.

Next, management apparatus 120 may use a power allocation policy to determine a priority of the load device based on the type and/or state of the load device. For example, management apparatus 120 may compare the power draws, battery levels, current loads, and/or types of load devices 132-140 connected to physical ports 150 to derive a ranking of load devices 132-140 by priority. A load device with a lower battery level, higher power draw, and/or higher current load may have a higher priority than a load device with a higher battery level, lower power draw, and/or lower current load.

To determine the priority of each load device, management apparatus 120 may combine attributes associated with the type and/or state of the load device into a priority score for the load device. For example, management apparatus 120 may assign individual scores to individual attributes (e.g., manufacturer, model, battery capacity, battery level, power draw, current load, etc.) of the load device and produce an overall priority score as a weighted combination of the individual scores. Alternatively, management apparatus 120 may use a set of rules to determine the priorities of load devices 132-140. For example, management apparatus 120 may estimate the remaining runtime of each load device based on the battery level, battery capacity, and current load of the load devices and order load devices 132-140 by increasing order of remaining runtime. Thus, a load device with a shorter estimated remaining runtime may have a higher priority than a load device with a longer estimated remaining runtime.

Management apparatus 120 may also use the power allocation policy to allocate power to load devices 132-140 according to the priorities of load devices 132-140. For example, management apparatus 120 may allocate a portion of available power from power supply 130 and power converter 112 to each load device based on the priority of the load device, up to the maximum power draw of the load device. If charging device 100 is not connected to power supply 130, management apparatus 120 may distribute power supplied by battery 110 among load devices 132-140. Each portion of allocated power may represent a discrete power level supported by physical ports 150. For example, management apparatus 120 may allocate 0.5 A, 1 A, 1.5 A, or 2 A of current at 5V to load devices 132-140 connected to USB physical ports 150 on charging device 100, with higher amounts of current allocated to higher-priority devices and lower amounts of current to lower-priority devices.

Upon detecting a connection of a new load device to a physical port on charging device 100 and/or the disconnection of a load device from a physical port on charging device 100, management apparatus 120 may reassess the priorities of the connected load devices 132-140 and reallocate power according to the reassessed priorities. For example, after a new load device is connected to charging device 100, management apparatus 120 may revoke existing power allocations to previously connected load devices and assigning new power allocations to accommodate power supplied to the new load device. Conversely, if a load device is disconnected from charging device 100, management apparatus 120 may divide the power previously allocated to the load device among the load devices still connected to charging device 100.

As mentioned above, some load devices may be incapable of communicating their types and/or states to charging device 100. As a result, management apparatus 120 may assign the lowest priority to the load devices and allocate a minimum amount of power (e.g., 100 mA, 0.5 A) to the load devices.

Management apparatus 120 may continually adjust the power allocations of load devices 132-140 based on changes to the states of load devices 132-140 over time. For example, management apparatus 120 may periodically monitor the states of load devices 132-140 and reduce the priority and power allocation of a load device after the battery level of the load device's battery exceeds a threshold (e.g., 80%). On the other hand, management apparatus 120 may increase the priority and power allocation of the load device if the battery level of the load device continues to drop due to a high current load that consumes more power than the power allocated over the physical port to which the load device is connected.

Management apparatus 120 may use the communications interface supported by physical ports 150 to communicate the allocated power to each load device 132-140. For load devices that are capable of communicating their types and/or states over physical ports 150, management apparatus 120 may use software commands (e.g., USB commands) to communicate an explicit power allocation to the load devices. In turn, the load devices may use internal power-limiting capabilities to draw only up to their power allocations from charging device 100.

On the other hand, if a load device is incapable of complex communication with charging device 100 (e.g., communicating the type and/or state of the load device to charging device 100), management apparatus 120 may physically limit the current drawn by the load device by emulating and/or communicating a particular type of physical port to the load device. For example, management apparatus 120 may allocate the minimum 0.5 A to a load device without using software commands to communicate with the load device by emulating a 100 mA low-power USB standard downstream port (SDP) or a 0.5 A high-power USB SDP using the D+ and D− lines of the physical USB port to which the load device is connected.

Management apparatus 120 may verify that load devices 132-140 adhere to their respective power allocations by monitoring the power draw of each load device and limiting the power supplied to the load device based on the monitored power draw and the power allocation of the load device. For example, management apparatus 120 may monitor the power draw of load devices 132-140 by measuring the current drawn by each load device in a return path from the physical port to which the load device is connected. Management apparatus 120 may prevent the power supplied to the load device from exceeding the power allocation by dropping the output voltage on the physical port if the load device attempts to draw more than the allocated current. Alternatively, management apparatus 120 may disconnect the load device from charging device 100 (e.g., using a protection switch coupled to the physical port) when the monitored power draw exceeds the power allocation of the load device.

Management apparatus 120 may further include functionality to manage the allocation of power to load devices 132-140 from power supply 130, power converter 112, and/or battery 110 based on a number of other factors. First, management apparatus 120 may use the monitored power draw of a load device to update the power allocation of the load device. For example, management apparatus 120 may detect that a first load device consistently draws all of the power allocated to the first load device and/or has a current load that is higher than the power allocation of the first load device, while a second load device has been drawing less than the power allocation of the second load device for a pre-specified period (e.g., a number of minutes). As a result, management apparatus 120 may reallocate power between the two load devices so that unused power previously allocated to the second load device can be drawn by the first load device.

Second, management apparatus 120 may operate battery 110 according to the priorities of load devices 132-140 connected to physical ports 150. As mentioned above, management apparatus 120 may be required to allocate limited power from power supply 130 and power converter 112 to multiple load devices 132-140 connected to physical ports 150, as well as an internal battery 110 in charging device 100. For example, management apparatus 120 may divide up to 12.5 W from power converter 112 into a portion for charging battery 110 (e.g., if battery 110 is not fully charged) and one or more portions for supplying power to one or more load devices 132-140 connected to physical ports 150.

To balance charging of battery 110 with supplying power to load devices 132-140, management apparatus 120 may allocate power for charging battery 110 based on the battery level (e.g., state-of-charge) of battery 110 and the priorities of load devices 132-140, as determined based on the types and/or states of load devices 132-140. For example, management apparatus 120 may assign a priority to battery 110 based on the state-of-charge of battery 110 and include battery 110 in the ranking of load devices 132-140 by priority. Management apparatus 120 may then allocate portions of available power from power supply 130 and power converter 112 to battery 110 and load devices 132-140 according to the ranking. Alternatively, management apparatus 120 may first allocate power to load devices 132-140 from power supply 130 and power converter 112 and use any remaining available power to charge battery 110. If all available power has been allocated to load devices 132-140, management apparatus 120 may disable charging of battery 110 before battery 110 reaches a fully charged state to increase power supplied to load devices 132-140. Management apparatus 120 may also supplement power from power supply 130 and power converter 112 with power from battery 110 if the priorities and/or power demands of one or more load devices 132-140 are high enough.

If charging device 100 is not coupled to power supply 130 and/or another external power source, management apparatus 120 may manage the allocation of power from discharging of battery 110 to load devices 132-140. Because battery 110 has a limited capacity, management apparatus 120 may allocate less power from battery 110 than from power converter 112 and power supply 130 to load devices 132-140. For example, management apparatus 120 may allocate up to 10 W of power from battery 110 to load devices 132-140 instead of up to 12.5 W of power from power converter 112 and power supply 130. In other words, management apparatus 120 may allocate power supplied to load devices 132-140 from battery 110 at a level that is lower than a maximum allocation of power on charging device 100 (e.g. 12.5 W while power supply 130 is connected).

Management apparatus 120 may also vary the power allocated from battery 110 based on the battery level of battery 110. For example, management apparatus 120 may allocate up to 10 W of power from battery 110 to load devices 132-140 if the battery level of battery 110 is between 80% and 100%. If the battery level drops below 80%, management apparatus 120 may reduce the total allocated power from battery 110 to 8 W. If the battery level drops below 60%, management apparatus 120 may reduce the total allocated power from battery 110 to 6 W. If the battery level drops below 40%, management apparatus 120 may reduce the total allocated power from battery 110 to 4 W. As a result, management apparatus 120 may extend the supply of power to load devices 132-140 from charging device 100 by reducing the amount of power supplied from battery 110 as battery 110 discharges.

To further slow the discharge of battery 110, management apparatus 120 may slow or discontinue the allocation of power to a load device as the battery level of the load device increases. For example, management apparatus 120 may initially allocate 1 A at 5V from battery 110 to a mobile phone with a battery level of 50%. After the battery level of the mobile phone rises to 70%, management apparatus 120 may reduce the power allocation to 0.5 A. Once the battery level of the mobile phone reaches 80%, management apparatus 120 may prevent the mobile phone from drawing additional power from battery 110 (e.g., by disconnecting the mobile phone from a physical port on charging device 100) to conserve battery 110 power for use by other load devices with lower battery levels.

Finally, management apparatus 120 may allocate power supplied to load devices 132-140 based on user input from one or more load devices 132-140. For example, a user may interact with buttons, sliders, drop-down menus, and/or other user-interface elements of a user interface on a portable electronic device connected to a physical port of charging device 100 to specify and/or modify the power allocation policy for supplying power to load devices 132-140 from charging device 100. Alternatively, charging device 100 may include input/output (I/O) devices and/or a user interface that allows the user to update the power allocation policy directly on charging device 100. Each load device 132-140 may be identified within the user interface by the manufacturer, model, serial number, and/or name of the load device, as communicated to charging device 100.

The user may provide the power allocation policy as an amount of allocated power (e.g., 100 mA, 0.5 A, 1 A, 2 A) for a given load device at various battery levels of the battery in the load device (e.g., 2 A at a battery level of less than 50%, 1 A at a battery level of 50% to 80%, 0.5 A at a battery level of 80% to 100%). The user may also specify an allocation of power for charging battery 110 from power supply 130 based on the battery level of battery 110. The user interface may restrict the power allocated to all connected load devices 132-140 to the maximum available power from power supply 130 and/or battery 110, which may vary depending on the coupling of power supply 130 to charging device 100 and/or the battery level of battery 110. Alternatively, the user interface may allow the user to adjust the maximum available power from power supply 130 and/or battery 110 at various battery levels, within certain operating limits. The power allocation policy may also include different values of allocated power and ranges of battery levels for supplying power to the load device from battery 110 and power supply 130.

Such priority-based power allocation may improve the utilization of a limited amount of power from power supply 130 and power converter 112 by multiple load devices 132-140 connected to physical ports 150. Similarly, the charging and discharging of battery 110 may be conducted based on the priorities of load devices 132-140 and the battery level of battery 110, thus balancing the runtime of battery 110 with the powering and/or charging of load devices 132-140 from battery 110.

Those skilled in the art will appreciate that the system of FIG. 1 may be implemented in a variety of ways. As described above, a number of physical interfaces and/or communication standards may be used with physical ports 150 to supply power to load devices 132-140 and/or enable communication with load devices 132-140. Moreover, management apparatus 120 may be provided by a combination of hardware and/or software components on charging device 100 and/or load devices 132-140. For example, management apparatus 120 may be implemented using a circuit, processor, firmware and/or application software on charging device 100, and/or a driver for one or more load devices 132-140. The operation of management apparatus 120 may thus be modified (e.g., to change the power allocation policy used by management apparatus 120) by updating the firmware, driver, and/or other software used to run management apparatus 120.

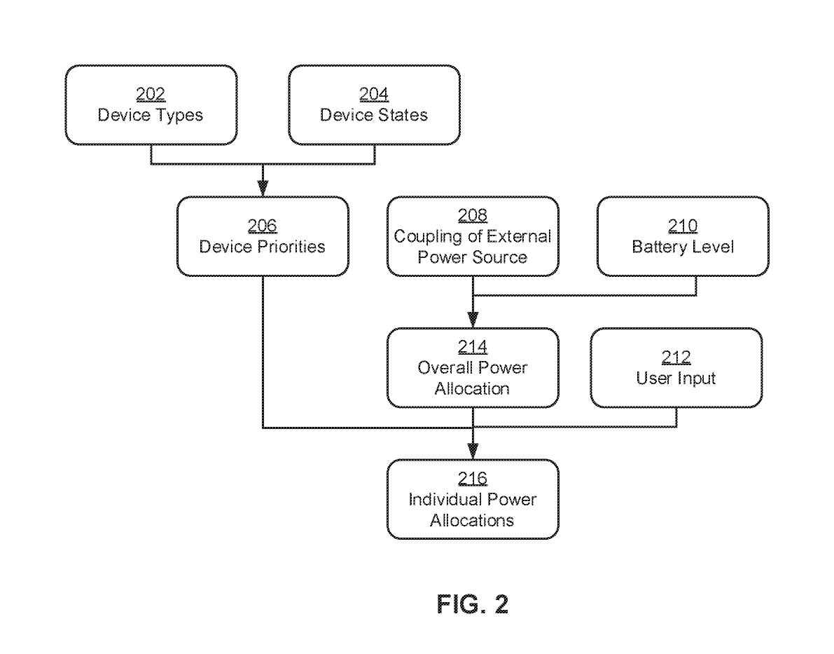

FIG. 2 shows the allocation of power to one or more load devices (e.g., load devices 132-140 of FIG. 1) connected to physical ports (e.g., physical ports 150 of FIG. 1) of a charging device (e.g., charging device 100 of FIG. 1) in accordance with the disclosed embodiments. First, device types 202 and device states 204 of the load devices are obtained and used to determine device priorities 206 of the load devices. Device types 202 may include the manufacturer, model, device name, device owner, functionality, operating parameters, and/or other characteristics that can be used to identify the load devices. Device states 204 may include the battery levels of batteries in the load devices, current loads on the load devices, power draws of the load devices, and/or values associated with current operation of the load devices. Device types 202 and/or device states 204 may be obtained by communicating with the load devices through communications interfaces supported by the physical ports.

Device priorities 206 may be determined by combining individual scores associated with attributes from device types 202 and device states 204 into an overall priority score for each load device and/or applying a set of rules to device types 202 and device states 204 to obtain a ranking of the load devices by priority. For example, a lower battery level, shorter estimated runtime, and/or higher current load may increase the priority of a load device, while a higher battery level, longer estimated runtime, and/or lower current load may decrease the priority of the load device. Load devices may also be prioritized by device type. For example, a load device that is capable of communicating its device type and device state to the charging device may have a higher priority than a load device that cannot communicate its device type and device state to the charging device. In another example, device types 202 of the load devices may be associated with different levels of importance, such that certain device types (e.g., device owners, form factors, functionality, etc.) may contribute slightly more to a load device's priority than other device types.

A coupling of an external power source 208 to the charging device and a battery level 210 of a battery (e.g., battery 110 of FIG. 1) in the charging device may then be used to determine an overall power allocation 214 to the load devices from the charging device. Coupling of external power source 208 may be a binary or Boolean value that indicates the presence or absence of a power supply (e.g., power supply 130 of FIG. 1) and/or other external power source for the charging device. Battery level 210 may represent the state-of-charge of the battery in the charging device.

The external power source may be used to supply power to the load devices through a power converter (e.g., power converter 112 of FIG. 1) in the charging device. The external power source may also be used to charge the battery in the charging device, if the battery is not in a fully charged state. On the other hand, the battery in the charging device may be discharged to supplement power from the external power source and/or if the external power source is not coupled to the charging device. Because the battery has limited capacity, the overall power allocation 214 to the load devices from the battery alone may be lower than the maximum power allocation of the charging device when the external power source is coupled to the charging device. Overall power allocation 214 may also vary based on battery level 210 during powering of the load devices from the battery of the charging device. For example, overall power allocation 214 to the load devices may be up to a maximum of 12.5 W if the external power source is coupled to the charging device and up to 10 W if the external power source is not coupled to the charging device and battery level 210 is at or near a fully charged state. As battery level 210 drops, overall power allocation 214 may decrease to extend the runtime of the battery in the charging device.

After overall power allocation 214 is obtained, device priorities 206, overall power allocation 214, and user input 212 may be used to determine individual power allocations 216 for the load devices. User input 212 may be provided by a user from a user interface on one or more load devices connected to the charging device. For example, user input 212 may specify a power allocation policy for allocating available power from the battery on the charging device and/or the external power source, if coupled, among load devices connected to the charging device.

To determine individual power allocations 216, a priority of a load device may be used to assign an individual power allocation to the load device as a discrete value (e.g., a number of watts, volts, and/or amperes), up to the maximum power that can be drawn by the load device. Individual power allocations 216 may also be assigned to the load devices so that overall power allocation 214 is not exceeded. If a new load device is connected to the charging device, individual power allocations 216 of one or more previously connected load devices may be reduced to accommodate the individual power allocation of the new load device.

User input 212 may be provided by a user from a user interface on one or more load devices connected to the charging device. For example, user input 212 may modify the power allocation policy used in dividing overall power allocation 214 among load devices connected to the charging device. As a result, user input 212 may be used to adjust device priorities 206 and/or individual power allocations 216. User input 212 may also be used to modify overall power allocation 214 within the operating limits of the charging device.

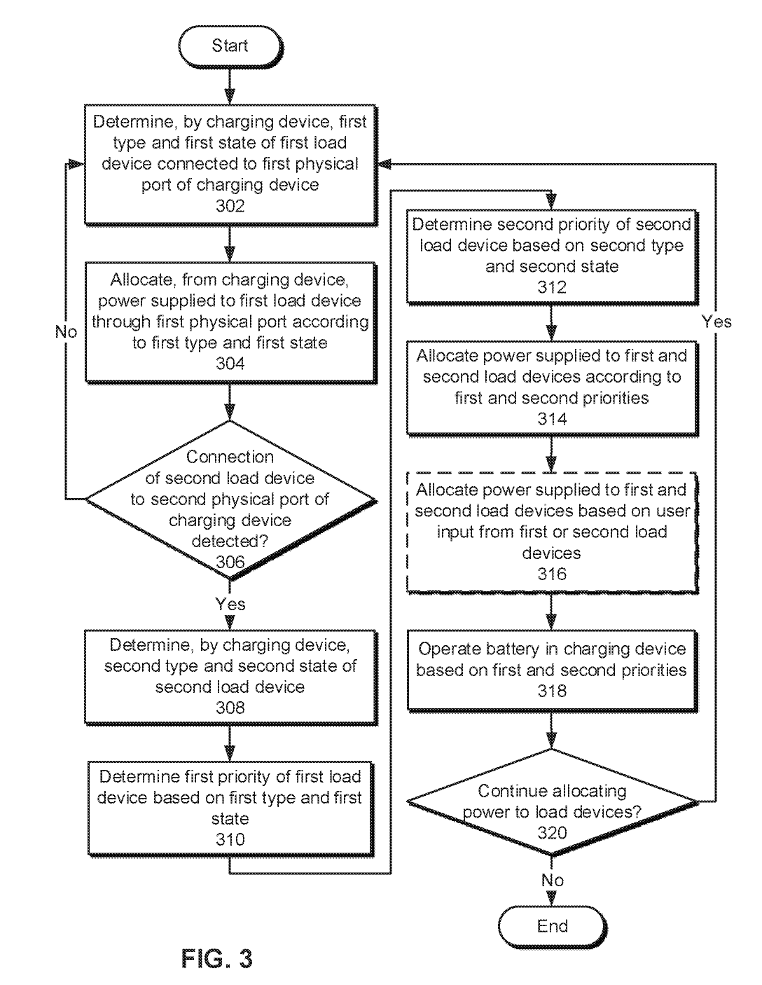

FIG. 3 shows a flowchart illustrating the process of managing power allocation in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a first type and a first state of a first load device connected to a first physical port of a charging device are determined by the charging device (operation 302). The first type of the first load device may include the manufacturer, model, device name, device owner, functionality, and/or other attributes associated with identification of the first load device. The first state of the first load device may include the battery level of a battery in the first load device, a current load on the first load device, and/or a power draw of the first load device.

Next, power supplied to the first load device through the first physical port is allocated from the charging device according to the first type and first state (operation 304). For example, power may be allocated to the first load device, up to the maximum power that can be drawn by the first load device and/or the maximum allocation of power on the charging device. The power supplied to the first load device may also be allocated based on a coupling of an external power source to the charging device. When the external power source is not coupled to the charging device, power supplied to the first load device may be allocated from a battery on the charging device at a level that is lower than the maximum allocation of power on the charging device. For example, up to 10 W may be allocated from the battery, while up to 12.5 W may be allocated from the external power source when the external power source is coupled to the charging device.

A connection of a second load device to a second physical port of the charging device may be detected (operation 306) by the charging device. For example, the charging device may detect the connection of the second load device to the second physical port through one or more pins in the second physical port. If the second load device is not connected to the second physical port, the first load device may continue to be powered and/or charged using operations 302-304. For example, the type and first state of the first load device may be periodically determined and used to allocate power supplied to the first load device while the first load device is connected to the charging device.

If a second device is connected to the second physical port of the charging device, the second type and second state of the second load device are determined (operation 308). A first priority of the first load device is then determined based on the first type and the first state (operation 310), and a second priority of the second load device is determined based on the second type and the second state (operation 312). Power supplied to the first and second devices is then allocated according to the first and second priorities (operation 314) and optionally based on user input from the first or second load devices (operation 316). For example, power from the charging device may be allocated to the first and second priorities so that a higher-priority load device has a higher power allocation than a lower-priority load device. The user input may be used to adjust the priorities and/or power allocations of the load devices.

The power allocations may be communicated to the first and second load devices using software commands that explicitly state the allocated power to a given load device and/or port types associated with the power allocations. For example, the charging device may communicate an explicit power allocation to a load device that is capable of providing its state and type to the charging device. On the other hand, the charging device may communicate and/or emulate a port type using one or more pins in a physical port to which the load device is connected if the load device is not capable of providing its state and type to the charging device.

After the power allocations are communicated, the charging device may monitor power draws of the load devices and limit the power supplied to the load devices based on the monitored power draws and power allocations. To limit the supply of power to the load devices, the charging device may prevent the supply of power to a given load device from exceeding the power allocation of the load device and/or disconnect the load device from the charging device when the power draw of the load device exceeds the power allocation.

The battery in the charging device is also operated based on the first and second priorities (operation 318). For example, the battery may be charged using remaining available power from the external power source and power converter. Alternatively, power may be supplied to the load devices from the battery if the external power source is not coupled to the charging device and/or if battery power is used to supplement available power from the external power source and/or power converter.

Power may continue to be allocated to the load devices (operation 320) while the load devices are connected to the charging device and/or power is available on the charging device. If power is to be allocated to the load devices, the charging device is used to periodically and/or continually determine the types, states, and/or priorities of the load devices and allocate power to the load devices according to the types, states, and/or priorities (operations 302-314). The charging device may further allocate power to the load devices based on user input (operation 316) and operate a battery in the charging device based on the priorities (operation 318) of the load devices. Such allocation of power to the load devices may thus continue until the load devices are no longer connected to the charging device and/or power is no longer available on the charging device (e.g., if the external power source is disconnected and the battery in the charging device is depleted).

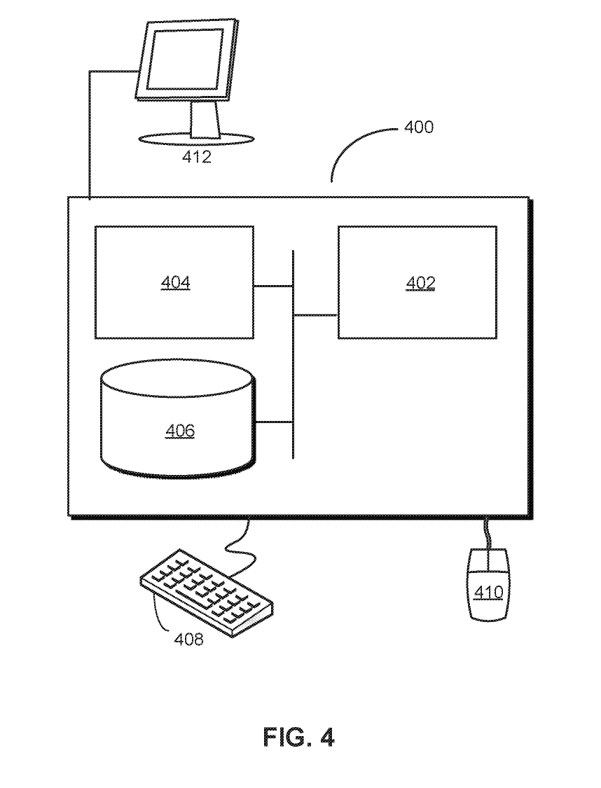

FIG. 4 shows a computer system 400 in accordance with the disclosed embodiments. Computer system 400 may correspond to an apparatus that includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for allocating power to a set of load devices. The system may include a battery, a set of physical ports, and a management apparatus. The management apparatus may determine a first type and a first state of a first load device connected to a first physical port and allocate power supplied to the first load device through the first physical port according to the first type and the first state of the first load device. The management apparatus may also determine a second type and a second state of a second load device connected to a second physical port and allocate power supplied to the second load device through the second physical port according to the second type and the second state of the second load device. The management apparatus may further determine priorities of the first and second load devices based on the types and states of the load devices and reallocate power supplied to the first and second load devices through the first and second physical ports according to the priorities.

In addition, one or more components of computer system 400 may be remotely located and connected to the other components over a network. Portions of the present embodiments (e.g., power converter, battery, management apparatus, external power source, etc.) may also be located on different nodes of a distributed system that implements the embodiments. For example, the present embodiments may be implemented using a cloud computing system that remotely manages and revokes power allocated to a set of remote load devices.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method for managing power allocation, comprising:
determining, by a charging device, a first type and a first state of a first load device connected to a first physical port of the charging device; and
allocating, from the charging device, power supplied to the first load device through the first physical port according to the first type and the first state of the first load device.

2. The method of claim 1, wherein allocating power supplied to the first load device through the first physical port comprises:
allocating the power supplied to the first load device through the first physical port based on a coupling of an external power source to the charging device.

3. The method of claim 2, wherein allocating the power supplied to the first load device based on the coupling of the external power source to the charging device comprises:
when the external power source is not coupled to the charging device, allocating the power supplied to the first load device from a battery on the charging device at a level that is lower than a maximum allocation of power on the charging device.

4. The method of claim 1, further comprising:
determining, by the charging device, a second type and a second state of a second load device connected to a second physical port of the charging device; and
allocating, from the charging device, power supplied to the second load device through the second physical port according to the second type and the second state of the second load device.

5. The method of claim 4, further comprising:
determining a first priority of the first load device based on the first type and the first state of the first load device;
determining a second priority of the second load device based on the second type and the second state of the second load device; and
reallocating power supplied to the first and second load devices through the first and second physical ports according to the first and second priorities.

6. The method of claim 5, further comprising:
operating a battery in the charging device based on the first and second priorities.

7. The method of claim 6, wherein operating the battery in the charging device based on the first and second priorities comprises one of:
disabling charging of the battery before the battery reaches a fully charged state to increase power supplied to the first and second load devices; and
allocating power for charging the battery based on a battery level of the battery and the first and second priorities.

8. The method of claim 5, wherein reallocating power supplied to the first and second load devices according to the first and second priorities comprises:
reducing power supplied to the first load device to accommodate the power supplied to the second load device.

9. The method of claim 5, wherein reallocation of the power supplied to the first and second load devices occurs upon detecting a connection of the second device to the second physical port of the charging device.

10. The method of claim 4, further comprising:
allocating power supplied to the first and second load devices based on user input from the first or second load devices.

11. The method of claim 1, wherein allocating power supplied to the first load device through the first physical port comprises:
communicating a power allocation for the first load device to the first load device through the first physical port.

12. The method of claim 11, wherein allocating power supplied to the first load device through the first physical port further comprises:
monitoring a power draw of the first load device; and
limiting the power supplied to the first load device based on the monitored power draw and the power allocation.

13. The method of claim 12, wherein limiting the power supplied to the first load device based on the monitored power draw and the power allocation comprises one of:
preventing the power supplied to the first load device from exceeding the power allocation; and
disconnecting the first load device from the charging device when the monitored power draw exceeds the power allocation.

14. The method of claim 11, wherein communicating the power allocation for the first load device comprises:
communicating a port type of the physical port to the first load device, wherein the port type is associated with the power allocation.

15. The method of claim 1, wherein the first state of the first load device comprises at least one of:
a battery level of a battery in the first load device;
a current load on the first load device; and
a power draw of the first load device.

16. A charging device, comprising:
a battery;
a first physical port; and
a management apparatus configured to:
determine a first type and a first state of a first load device connected to the first physical port; and
allocate power supplied to the first load device through the first physical port according to the first type and the first state of the first load device.

17. The charging device of claim 16, further comprising:
a second physical port,
wherein the management apparatus is further configured to:
determine a second type and a second state of a second load device connected to the second physical port; and
allocate power supplied to the second load device through the second physical port according to the second type and the second state of the second load device.

18. The charging device of claim 17, wherein the management apparatus is further configured to:
determine a first priority of the first load device based on the first type and the first state of the first load device;
determine a second priority of the second load device based on the second type and the second state of the second load device; and
reallocate power supplied to the first and second load devices through the first and second physical ports according to the first and second priorities.

19. The charging device of claim 18, wherein the management apparatus is further configured to:
operate the battery based on the first and second priorities.

20. The charging device of claim 16, wherein the management apparatus is further configured to:
allocate the power supplied to the first load device through the first physical port based on a coupling of an external power source to the charging device.

21. The charging device of claim 16, wherein the management apparatus is further configured to:
allocate power supplied to the first and second load devices based on user input from the first or second load devices.

22. A non-transitory computer-readable storage medium containing instructions that, when executed by a controller, cause the controller to perform a method for managing power allocation, the method comprising:
determining, by a charging device, a first type and a first state of a first load device connected to a first physical port of the charging device; and
allocating, from the charging device, power supplied to the first load device through the first physical port according to the first type and the first state of the first load device.

23. The non-transitory computer-readable storage medium of claim 22, the method further comprising:
allocating the power supplied to the first load device through the first physical port based on a coupling of an external power source to the charging device.

24. The non-transitory computer-readable storage medium of claim 22, the method further comprising:
determining, by the charging device, a second type and a second state of a second load device connected to a second physical port of the charging device; and
allocating, from the charging device, power supplied to the second load device through the second physical port according to the second type and the second state of the second load device.

25. The non-transitory computer-readable storage medium of claim 24, the method further comprising:
determining a first priority of the first load device based on the first type and the first state of the first load device;
determining a second priority of the second load device based on the second type and the second state of the second load device; and
reallocating power supplied to the first and second load devices through the first and second physical ports according to the first and second priorities.

26. A method for managing power allocation, comprising:
determining, by a charging device, a first type and a first state of a first load device connected to a first physical port of the charging device; and
allocating, from the charging device, power supplied to the first load device through the first physical port according to the first type and the first state of the first load device, wherein allocating power supplied to the first load device through the first physical port comprises allocating the power supplied to the first load device through the first physical port based on a coupling of an external power source to the charging device.
